(19) United States
(12) Patent Application Publication
(10) Pub. No.: US 2004/0093189 A1
(43) Pub. Date: May 13, 2004

(54) Method for the asynchronous space saving data acquisition within a continuous measured value storage

(76) Inventors: Wolfgang Schworer, Loffingen (DE); Meinrad Gotz, Bonndorf (DE)

Correspondence Address: Choate Hall & Stewart, Patent Group, Exchange Place, 53 State Street, Boston, MA, 02109-2804, US

(21) Appl. No.: 10/471,316

(22) PCT Filed: Mar. 11, 2002
(86) PCT No.: PCT/EP02/02651

(30) Foreign Application Priority Data
Mar. 14, 2001 (DE) 101 12 038.9

(51) Int. Cl. G01D 9/00

(52) U.S. Cl. 702/189

(57) ABSTRACT

The invention relates to a method for the acquisition and storage of measured values, according to which measured values (MW1i, MW2i, MW3i) are continuously acquired by at least one sensor in a predefined first measurement interval (T1). The acquired measured values (MW1i, MW2i, MW3i) are stored in a measured value memory (K1, K2, K3). The invention is further characterized in that upon occurrence (EA) of an event detected by an event sensor one or more further measured value(s) (MW14, MW15, MW16, MW17, MW18, MW19, MW110, MW24, MW25, MW26, MW27, MW28, MW29, MW210, MW34, MW35, MW36, MW37, MW38, MW39, MW310) are acquired by the at least one sensor and/or one or more further measured values are acquired with a further measurement interval (T2) in an asynchronous manner to the first measurement interval (T1) and are stored in the measured value memory (K1, K2, K3).

The present invention relates to a method according to the definition of the species in claim 1.

Measuring instruments or the like are known from the related art, which, triggered by the occurrence of a certain event such as, for example, the opening of a door or the like, gather and store, in an especially provided measuring-data memory, one or several items of measuring data in fixedly predetermined and as a rule equal time intervals. Measured value gathering is aborted in the same way, preferably due to the fact that the above-mentioned event is no longer occurring, e.g., when the above-mentioned door contact is closed again. Prior to the occurrence of the above-mentioned event or after the above-mentioned event is no longer occurring no measured-values are gathered or stored.

Measured value acquisition and storage methods according to the present invention are used in those cases in which measured values are to be gathered and stored during these periods; continuous measured values are gathered by at least one measured value sensor in a fixedly predetermined first measuring cycle and the measured values gathered are stored in a measured value memory. Furthermore, the time of the occurrence of the event, as well as the non-occurrence of the event is additionally stored in order to obtain a corresponding allocation. Any further storage measures are omitted due to the large memory required.

It is thus the object of the present invention to design and refine the known methods of measured value acquisition and storage in such a way that measured value acquisition and storage adapted to a special event is possible without a substantially greater memory space being required.

This object is achieved according to the present invention by using a method for measured value acquisition and storage as recited in the preamble of claim 1.

Advantageous embodiments and refinements of the present invention are stated in the subclaims.

The essential idea of the present invention is the fact that subsequently to the occurrence of an event gathered by an event sensor, one or several additional measured values are gathered asynchronously to the first measuring cycle by the at least one measured value sensor and/or by at least one additional measured value sensor, the measured values being stored in the measured value memory. In this way, the measured-data acquisition is instantaneously adapted to the occurrence of an event. This is particularly appropriate when the measured value acquisition takes place in great time intervals during the first measuring cycle, so that in the method according to the related art changes of state due to the occurrence of the event are not detected. In the method according to the present invention, a memory space is only to be provided directly at the occurrence of the event. Moreover, no additional measuring channel is required.

A particularly advantageous variant of the present invention provides that further measured values are gathered in a fixedly predetermined second measuring cycle (which may or may not be identical to the first measuring cycle). A plurality of applications is comprehensively covered by this method, in particular in the areas of food distribution and food warehousing. Using this method, the temperature variation in the cargo space of a truck when the truck doors are open and the temperature variation in a food container when the container cover is open may be detected in real time and may be documented precisely via the variable measuring cycle. A measuring rate, adapted to the event, is performed which makes it possible to accurately follow the change from a static system (e.g., the temperature variation with a closed food container) to a dynamic system (e.g., a subsequent opening of the food container cover).

A further variant of the present invention provides that further measured values are gathered as long as the event continues to exist. This variant ensures that the preferably increased measuring rate and thus an increased memory requirement are only maintained as long as high dynamics of the measured variable is anticipated. At times when only a minor variation of the measured value is to be anticipated, measured value acquisition and storage are omitted.

A particularly advantageous variant of the present invention provides that, as a result of non-occurrence of the event (as detected by the event sensor), one or several additional measured value(s) are gathered by the at least one measured value sensor and/or by the at least one further measured value sensor asynchronously to the first measuring cycle and/or asynchronously with the second measuring cycle, the additional measured values being stored in the measured value memory. This design of the present invention is a logical consequence of the modified measured value acquisition due to an asychronous occurrence of an event. Since, in the case of an asynchronous non-occurrence of an event, as well as in the case of an asynchronous occurrence of an event, a strong variation of one of the above-mentioned measured values is to be anticipated, it is appropriate at this point in time to again perform a measurement and storage of the measured value.

A further variant of the present invention provides that the additional measured values are included in the fixedly predetermined first measuring cycle. This consequently means that a measuring cycle is associated with each state detected by one or several event sensors. Thus, measured value acquisition specifically tailored to the respective state takes place. If high dynamics of a measured value is anticipated, a high frequency measuring cycle is preferably applied to that state; if, however, low dynamics of the measured value is anticipated, a low cycle frequency of the measuring cycle is preferably chosen. It is not impossible here that different measuring cycles are associated with different measured value sensors (associated with individual measuring channels as a rule).

Another preferred variant of the present invention provides that the time of the measured value acquisition start is stored in the measured value memory at the beginning of the measured value acquisition. This point in time, preferably an absolute time, is used for the reconstruction and the chronological allocation of each series of measurements.

Another preferred variant of the present invention provides that, for each stored measured value, the time difference between its measured value acquisition time and the measured value acquisition time of the previous measured value is stored in the measured value memory. This variant of the present invention is particularly advantageous if, as in the above-mentioned case, the occurrence of an event is to be exactly determined and/or if the time of non-occurrence of the event is significant. If this is not the case, it is sufficient in principle to only apply different measuring cycles to different events or states, so that in this way a reconstruction of the chronological measured value sequence is possible.

According to the present invention, the time difference is stored as a 15-bit data word. At a time resolution of one second, the slowest measuring rate is 32,767 seconds, or approximately 9.1 hours. Of course, scaling in 100 milliseconds, 10 milliseconds, 1 millisecond, etc., is possible, whereby each time resolution is increased by the factor 10 vis-a-vis the previous resolution. At the same memory width, the slowest measuring cycle is reduced by the factor 10.

A particularly advantageous design of the present invention provides that, for each stored measured value, the state of the event is stored in the measured value memory. This memory organization makes it possible to perform and to store asynchronous measurements within the measuring cycles predetermined by the instrument and also to additionally implement two different measuring rates, depending on the state of the external signal.

Another variant of the present invention provides that the state of the event is stored as a 1-bit data word. This, together with the 15-bit data word for the time difference, results in a 16-bit data word which corresponds to the usual memories having 16-bit memory structures.

It is also provided that the measured values are stored as 15 bit data words having a sign bit each. This makes it possible to establish a numerical range between −32,768 and +32,767, allocation to the above-mentioned time memory and the event memory preferably taking place. Each measured value thus includes a 16-bit data word from whose absolute value (incl. sign) and the chronological allocation (incl. event state) also including a 16-bit data word. If several measuring channels are used, it is of course sufficient (as long as the measured value acquisition in the individual channels takes place simultaneously) to provide only one memory for the time and the respective state of the event which is associated with all measuring channels.

The present invention provides that temperature sensors, air moisture sensors, flow sensors, flue gas sensors, and/or the like such as e.g., CO₂, pH, air moisture sensors are used as measured value sensors. In principle, the type of sensor used is not subject to limitation.

Another advantageous variant of the present invention provides that at least one door contact and/or one measured value sensor is used as event sensor. It is provided in particular that the opening or closing of the door contact, exceeding or dropping below a threshold, exceeding or dropping below the modification of a measuring signal, or the like represent the event. All above-mentioned events are suitable to be represented by a 1-bit data word, which means in particular that the presence of a respective event is representable by a logical “1”, for example, and the non-presence or non-occurrence of the respective event is representable by a logical “0.”

An exemplary embodiment of the present invention is illustrated in the drawing and is explained in greater detail in the following.

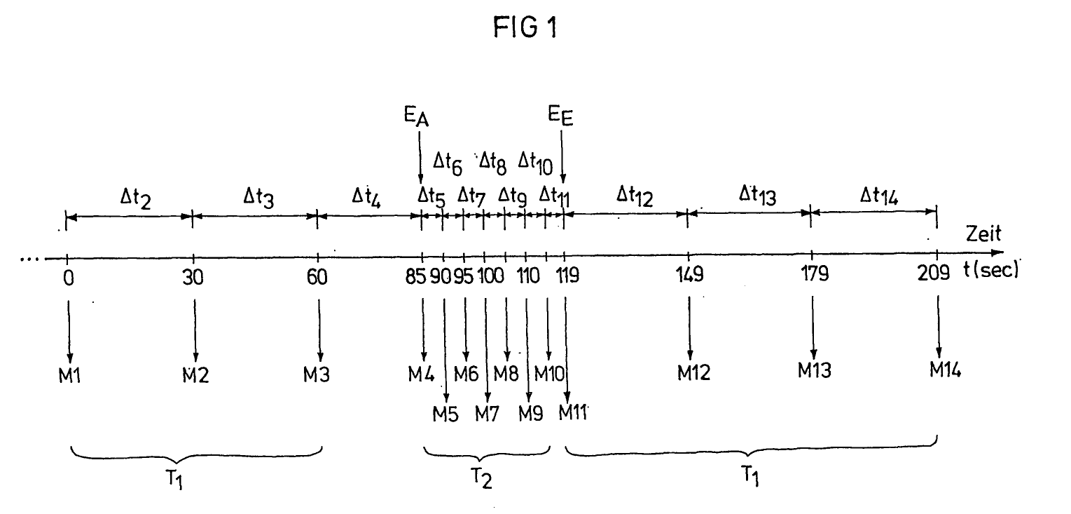

FIG. 1 shows a sequence diagram for the gathering of measured values over time.

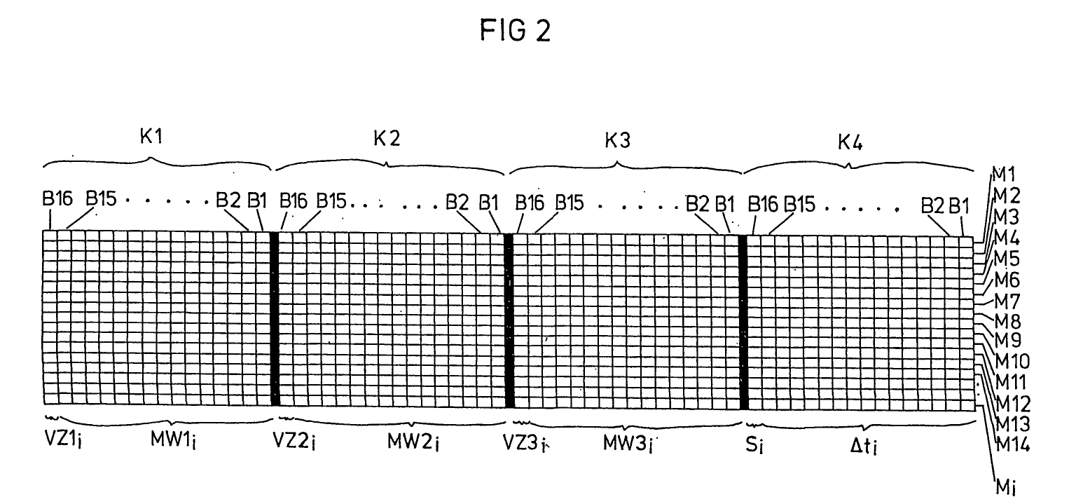

FIG. 2 shows a configuration of a measured value memory.

In general, FIGS. 1 and 2 show as an example the memory space-saving method according to the present invention for asynchronous data acquisition within a continuous measured value storage.

A continuous measured value acquisition and storage of different measured variables MW1, MW2, MW3, e.g., temperature, humidity, flow etc., in a fixedly set measuring cycle initially takes place in the method. An asynchronous occurrence EA of an event (e.g., closing of a door contact, exceeding or dropping below a measured value or measured value gradient) may trigger a measurement asynchronous with the previous measuring cycle T1 and the measuring result may be stored. As long as the event triggering the measurement continues to exist, another measuring cycle T2 may be activated. When the external event asynchronously ceases to exist, a new measurement is performed, the measured values MW1, MW2, MW3 are stored, and switching to the previous measuring cycle T1 takes place.

The function of the storage-saving storage process is explained in detail below:

If a measuring instrument is preprogrammed for a measuring sequence, the following values, among others, may be stored in the instrument:

Measuring cycle T1 for an external signal S=“0”

(corresponding to “normal state”—no event—): e.g., 30 seconds.

Measuring cycle T2 for an external signal S=“1”

(corresponding to “modified state”—occurrence of event—): e.g., 5 seconds.

Number of channels to be measured: e.g., 3 channels K1, K2, K3

Starting date and starting time of the measuring instrument t1=0:

On Dec. 10, 2000 e.g., at 5:15 p.m.

It is intended to store the measured values in a storage space-saving manner as 15 bit numbers plus a sign bit. This makes it possible to create a numerical range between −32,768 and +32,767. In addition to each measured value (thus three measured values MW1, MW2, MW3 for three channels K1, K2, K3), the time interval (also as a 15 bit number) to the previous measurement is stored expressed in seconds. Through this scaling and this memory variable, the slowest measuring rate may be 32,767 seconds (approximately 9.1 hours) and external events may be temporally resolved to 1 second.

Of course, scaling in 100 ms, 10 ms, 1 ms, etc., is also possible, whereby each time resolution in increased by the factor 10. For the same memory width, the slowest measuring cycle is reduced by the factor 10. This may be compensated, however, by increasing the memory width.

The sixteenth bit of the 16-bit memory is used as the state bit of the external signal S. This memory organization makes it possible to perform and to store asynchronous measurements within the measuring cycle T1, T2 predetermined by the (measuring) instrument and also to additionally implement two different measuring rates, depending on the state S=“1” or S=“0” of the external signal.

The chronological course of the method according to the present invention and the associated memory organization are described in greater detail in the following. For this purpose, the diagram according to FIG. 1 shows as an example how “event-controlled” measured values are acquired in the “time-controlled” log operation.

The method according to the present invention is illustrated by an example below:

M1) The measurement is started. The door contact is opened; the external signal S shows the value “0”. The first measured value acquisition M1 takes place at time t1=0 seconds. Measured value acquisition M1 is triggered by using a clock, a start button, a start signal, or via a PC. In the example, a cycle rate of 30 seconds is set as measuring cycle T1, so that the time-controlled measurements take place after t2=30 seconds, t3=60 seconds, t4=90 seconds, etc., provided no external event interferes with the measuring process. Time interval Δti between the i-th and the (i-1)-th measured value acquisition Mi and M (i-1) is thus Δti=30 seconds.

M2) A second time-controlled measured value acquisition M2 takes place after t2=30 seconds.

M3) A third time-controlled measured value acquisition M3 takes place after t3=60 seconds.

M4) After 25 seconds, thus asynchronously with the 30-second measuring cycle T1, door contact (Signal S=“1”) closes. This triggers measured value acquisition M4 at the time of closing. Subsequently to their acquisition, measured values MW14, MW24, and MW34 are stored in their storage spaces provided for each, and switching to the second measuring cycle T2 takes place. The cycle rate of measuring cycle T2 is 5 seconds in the example.

M5-M10) As long as the door contact is closed, the (measuring) instrument, for example, measures in a 5 second frequency (Δti=5 seconds) of the second measuring cycle T2. Measuring values MW1i, MW2i, MW3i where 1=5 . . . 10 are acquired at the points in time t5=90 seconds, t6=96 seconds, t7=100 seconds, t8=105 seconds, t9=110 seconds, t10=115 seconds.

M11) Door contact (Signal S=“0”) opens asynchronously with 5-second measuring cycle T2. In the example, this is the case after another 4 seconds. This triggers measured value acquisition M11 at the time of opening (t11=119 seconds), measured values MW111, MW211, and MW311 are stored, and switching back to the first measuring cycle T1 takes place (here: Δti=30 seconds).

M12-M14 Starting from point in time t11 of the eleventh measured value acquisition M11, the subsequent measurements are again performed every 30 seconds.

The memory organization during measured value acquisition is thus as follows:

The starting time and the starting date are stored in the instrument at point in time t1. Beginning at this starting date, the memory is “filled” as explained in Table 1.

TABLE 1
Memory Organization

| Measured | Measured | Measured | | | |
|---|---|---|---|---|---|
| Values | Values | Values | Switch | Time | Reference |
| Channel 1 | Channel 2 | Channel 3 | State S | Difference | to |
| - K1 - | - K2 - | - K3 - | - K4 - | Δti | Diagram |
| 23° C. | 45° C. | −15° C. | 0 | 0 (sec) | M1 |
| 25.4° C. | 43.6° C. | −15.3° C. | 0 | 30 (sec) | M2 |
| 25.8° C. | 47.2° C. | −14.2° C. | 0 | 30 (sec) | M3 |
| 26.1° C. | 51.7° C. | −13.9° C. | 1 | 25 (sec) | M4 |
| 25.5° C. | 51.9° C. | −14.1° C. | 1 | 5 (sec) | M5 |
| 26.7° C. | 52.4° C. | −14.3° C. | 1 | 5 (sec) | M6 |
| 26.9° C. | 52.9° C. | −14.6° C. | 1 | 5 (sec) | M7 |
| 26.3° C. | 51.6° C. | −14.4° C. | 1 | 5 (sec) | M8 |
| 26.1° C. | 51.2° C. | −14.3° C. | 1 | 5 (sec) | M9 |
| 25.8° C. | 50.9° C. | −13.9° C. | 1 | 5 (sec) | M10 |
| 26.7° C. | 50.9° C. | −14.0° C. | 0 | 4 (sec) | M11 |
| 26.2° C. | 51.5° C. | −13.5° C. | 0 | 30 (sec) | M12 |
| 25.7° C. | 50.4° C. | −13.0° C. | 0 | 30 (sec) | M13 |
| 25.2° C. | 49.9° C. | −12.6° C. | 0 | 30 (sec) | M14 |

The corresponding bit assignment is illustrated in FIG. 2 as follows:

Time difference (Δti), between measured value acquisition time (ti) of the instantaneous measured value (MW1i, MW2i, MW3i) and measured value acquisition time (ti-1) of the previous measured value (MW1i-1, MW2i-1, MW3i-1), assigned to each stored measured value (MW1i, MW2i, MW3i), is stored in measured value memory (K4) in such a way that time difference (Δti) is stored as a 15-bit data word B1, B2, B3, B4, B5, B6, B7, B8, B9, B10, B11, B12, B13, B14, B15. In addition to each stored measured value MW1i, MW2i, MW3i, the state Si of the event is stored in measured value memory K4, the latter being stored as one bit data word B16. Measured values MW1i, MW2i, MW3i are stored as 15-bit data words, and each assigned a sign bit. The latter is identified by reference number B16 in connection with Vz1i, Vz2i, and Vz3i.

This method has the following advantages:

This method provides a time-controlled instrument which responds to asynchronous events in that measured values relevant at the time of the event are stored and (if so desired) the measuring cycle is switched.

The memory is optimally utilized by using the selected storage method, since neither the time of day nor the date has to be stored. Due to the simultaneous storage of the time difference to the last measurement and the state of the event contact, the reading device (e.g., a personal computer (PC) or the like, or a terminal), beginning with the starting time once stored, may display the precisely timed “logged” measured values and events.

It is thus possible to acquire, store, and display asynchronous events within a time-controlled logging process.

What is claimed is:

1. A method of measured value acquisition and storage in which measured values (MW11, MW2i, MW3i) are continuously gathered by at least one measured value sensor in a fixedly predetermined first measuring cycle (T1), and the measured values (MW1i, MW2i, MW3i) gathered are stored in a measured value memory (K1, K2, K3), wherein, due to the occurrence of an event, detected by an event sensor, one or several other measured value(s) (MW14, MW15, MW16, MW17, MW18, MW19, MW110, MW24, MW25, MW26, MW27, MW28, MW29, MW210, MW34, MW35, MW36, MW37, MW38, MW39, MW310) are gathered by the at least one measured value sensor and/or by at least one additional measured value sensor asynchronously with the first measuring cycle (T1) or any other measuring cycle (T2) and are stored in the measured value memory (K1, K2, K3).

2. The method as recited in claim 1, wherein the additional measured values (MW14, MW15, MW16, MW17, MW18, MW19, MW110, MW24, MW25, MW26, MW27, MW28, MW29, MW210, MW34, MW35, MW36, MW37, MW38, MW39, MW310) are gathered in a fixedly predetermined second measuring cycle (T2).

3. The method as recited in claim 1 or claim 2, wherein the additional measured values (MW14, MW15, MW16, MW17, MW18, MW19, MW110, MW24, MW25, MW26, MW27, MW28, MW29, MW210, MW34, MW35, MW36, MW37, MW38, MW39, MW310) are gathered as long as the event (EA, EE) continues to exist.

4. The method as recited in one of the preceding claims, wherein, due to the non-occurrence (EE) of the event, detected by the event sensor, one or several additional measured value(s) (MW111, MW112, MW113, MW114, MW211, MW212, MW213, MW214, MW311, MW312, MW313, MW314) are gathered by the at least one measured value sensor and/or the at least one other measured value sensor asynchronously with the first measuring cycle (T1) and/or asynchronously with the second measuring cycle (T2) and are stored in the measured value memory (K1, K2, K3).

5. The method as recited in claim 4, wherein the additional measured values (MW111, MW112, MW113, MW114, MW211, MW212, MW213, MW214, MW311, MW312, MW313, MW314) are gathered in the fixedly predetermined first measuring cycle (T1).

6. The method as recited in one of the preceding claims, wherein at the start (t1) of the measured value acquisition (M1), the point in time of the measured value acquisition start is stored in the measured value memory (K4).

7. The method as recited in one of the preceding claims, wherein the time difference (Δti), between measured value acquisition time (t1) of the instantaneous measured values and measured value acquisition time (ti-1) of the previous measured values (MW1i-1, MW2i-1, MW3i-1), associated with each stored measured value (MW1i, MW2i, MW3i where i=2 . . . 14)), is stored in the measured value memory (K4).

8. The method as recited in claim 7, wherein the time difference (Δti) is stored as a 15-bit data word (B1, B2, B3, B4, B5, B6, B7, B8, B9, B10, B11, B12, B13, B14, B15).

9. The method as recited in one of the preceding claims, wherein the state (Si) of the event is stored for each stored measured value (MW1i, MW2i, MW3i) in the measured value memory (K4).

10. The method as recited in claim 9, wherein the state (Si) of the event is stored as a 1-bit data word (B16).

11. The method as recited in one of the preceding claims, wherein the measured values (MW1i, MW2i, MW3i) are stored as 15 bit data words (B1, B2, B3, B4, B5, B6, B7, B8, B9, B10, B11, B12, B13, B14, B15) plus one sign bit (B16, Vz1i, Vz2i, Vz3i) each.

12. The method as recited in one of the preceding claims, wherein at least one temperature sensor, at least one air moisture sensor, at least one flow sensor, and/or the like is used as the measured value sensor.

13. The method as recited in one of the preceding claims, wherein at least one door contact and/or one measured value sensor is used as the event sensor.

14. The method as recited in one of the preceding claims, wherein the event is the closing of a door contact, the excess or dropping below a threshold value, the excess or dropping below a change of a measuring signal, or the like.
